(19) United States
(12) Patent Application Publication
(10) Pub. No.: US 2026/0281305 A1
(43) Pub. Date: Sep. 17, 2026

(54) METHOD AND DEVICE FOR VIDEO CODING USING BIDIRECTIONAL PREDICTION BASED ON MOTION VECTOR CORRECTION

(71) Applicants: HYUNDAI MOTOR COMPANY, Seoul (KR); KIA CORPORATION, Seoul (KR); RESEARCH & BUSINESS FOUNDATION SUNGKYUNKWAN UNIVERSITY, Suwon-si (KR)

(72) Inventors: Byeung Woo Jeon, Seongnam-si (KR); Jong Hoon YIm, Suwon-si (KR); Jung Ah Choi, Seoul (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); RESEARCH & BUSINESS FOUNDATION SUNGKYUNKWAN UNIVERSITY, Suwon-si (KR)

(21) Appl. No.: 19/469,279

(22) PCT Filed: Feb. 1, 2024
(86) PCT No.: PCT/KR2024/001551

§ 371 Date: Sep. 25, 2025

(30) Foreign Application Priority Data
Apr. 13, 2023 (KR) 10-2023-0048702
Jan. 31, 2024 (KR) 10-2024-0015111

(51) Int. Cl. H04N 19/105; H04N 19/11; H04N 19/139; H04N 19/159; H04N 19/172; H04N 19/176; H04N 19/463; H04N 19/52; H04N 19/56; H04N 19/573; H04N 19/593

(52) U.S. Cl. CPC H04N 19/105; H04N 19/11; H04N 19/139; H04N 19/159; H04N 19/172; H04N 19/176; H04N 19/463; H04N 19/52; H04N 19/56; H04N 19/573; H04N 19/593

(57) ABSTRACT

A method and an apparatus are disclosed for video coding using bidirectional prediction based on motion vector refinement. In the disclosed embodiments, the video decoding device obtains a first reference picture and a second reference picture of the current block. The video decoding device generates a first motion vector of the current block and generates first predictor of the current block by using the first motion vector and the first reference picture. The video decoding device generates a comparative block by using at least one of the first predictor or an intra predictor of the current block and searches for a block having a minimum difference from the comparative block, within a preset search range on the second reference picture. The video decoding device refines a second motion vector by a vector indicative of a searched block. The video decoding device generates a second predictor of the current block.

### TECHNICAL FIELD

The present disclosure relates to a video coding method and an apparatus using bidirectional prediction based on motion vector refinement.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

There is a symmetric motion vector difference (SMVD) technique that can reduce the amount of bits transmitted compared to regular advanced motion vector prediction (regular AMVP) mode, even if just a single direction of motion vector difference (MVD) is signaled during bidirectional prediction or bi-prediction. SMVD searches for a combination of an L0 reference picture and an L1 reference picture that are in opposite directions in the display order relative to the current picture. Like regular AMVP, the SMVD technique generates motion vector predictors (MVPs) in the L0 and L1 directions. The SMVD technique receives an MVD signaled in one direction, and then adds the signaled MVD to the motion vector predictor in the L0 direction to generate a motion vector mvL0 in the L0 direction. The SMVD technique also adds the sign-inverted-MVD to the motion vector predictor in the L1 direction to generate another motion vector mvL1 in the L1 direction.

According to a conventional SMVD technique, the decoder is only signaled the MVD in the L0 direction and uses the sign-inverted-MVD in generating the other motion vector in the L1 direction. At this time, the signaled MVD may not be optimal for generating the other motion vector in the L1 direction. Additionally, since the current picture may not be temporally centered between the two reference pictures, the other motion vector in the L1 direction may not be generated properly when the object in the picture is moving at a constant speed. Therefore, to increase video coding efficiency and enhance video quality, there is a need to effectively refine the motion vector in the direction where the MVD is not delivered.

### DISCLOSURE

### Technical Problem

The present disclosure seeks to provide a video coding method and an apparatus that, when signaled in a bidirectional prediction a motion vector difference in one direction (e.g., L0 direction), but not signaled the motion vector difference in the other direction (e.g., L1 direction), use a predictor and/or intra predictor in the L0 direction to effectively refine the motion vector in the L1 direction.

### Technical Solution

At least one aspect of the present disclosure provides a method of reconstructing a current block by a video decoding apparatus. The method includes obtaining a first reference picture and a second reference picture of the current block, with a current picture existing temporally between the first reference picture and the second reference picture. The method also includes generating a first motion vector of the current block. The method also includes generating a first predictor of the current block by using the first motion vector and the first reference picture. The method also includes generating a comparative block by using at least one of the first predictor or an intra predictor of the current block. The method also includes searching for a block having a minimum difference from the comparative block, within a preset search range on the second reference picture. The method also includes refining a second motion vector by a vector indicative of a searched block.

Another aspect of the present disclosure provides a method of encoding a current block by a video encoding apparatus. The method includes obtaining a first reference picture and a second reference picture of the current block, with a current picture existing temporally between the first reference picture and the second reference picture. The method also includes determining a first motion vector and a second motion vector of the current block. The method also includes generating a first predictor of the current block by using the first motion vector and the first reference picture, and generating a second predictor of the current block by using the second motion vector and the second reference picture. The method also includes generating a first bidirectional prediction block of the current block by using the first predictor and the second predictor. The method also includes generating a comparative block by using at least one of the first predictor or an intra predictor of the current block. The method also includes searching for a block having a minimum difference from the comparative block, within a preset search range on the second reference picture. The method also includes refining the second motion vector with a vector indicative of a searched block. The method also includes generating a refined second predictor by using a refined second motion vector and the second reference picture. The method also includes generating a second bidirectional prediction block of the current block by using the first predictor and the refined second predictor.

Yet another aspect of the present disclosure provides a computer-readable recording medium storing a bitstream generated by a video encoding method. The video encoding method includes obtaining a first reference picture and a second reference picture of a current block, with a current picture existing temporally between the first reference picture and the second reference picture. The video encoding method also includes determining a first motion vector and a second motion vector of the current block; generating a first predictor of the current block by using the first motion vector and the first reference picture, and generating a second predictor of the current block by using the second motion vector and the second reference picture. The video encoding method also includes generating a first bidirectional prediction block of the current block by using the first predictor and the second predictor. The video encoding method also includes generating a comparative block by using at least one of the first predictor or an intra predictor of the current block. The video encoding method also includes searching for a block having a minimum difference from the comparative block, within a preset search range on the second reference picture. The video encoding method also includes refining the second motion vector with a vector indicative of a searched block. The video encoding method also includes generating a refined second predictor by using a refined second motion vector and the second reference picture. The video encoding method also includes generating a second bidirectional prediction block of the current block by using the first predictor and the refined second predictor.

### Advantageous Effects

As described above, the present disclosure provides a video coding method and an apparatus that utilize intra mode information in intra-template matching prediction to adaptively filter reference blocks according to template matching. Thus, the video coding method and the apparatus increase objective video coding efficiency and enhance subjective video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating motion vector generation according to the symmetric motion vector difference (SMVD) technique.

FIGS. 7A and 7 are diagrams illustrating the search of reference picture indices according to the SMVD technique.

FIG. 8 is a diagram illustrating a case where the current picture is not temporally centered between two reference pictures.

FIG. 9 is a diagram illustrating a refinement of an L1 motion vector, according to at least one embodiment of the present disclosure.

FIG. 10 is a diagram illustrating a refinement of an L1 motion vector, according to another embodiment of the present disclosure.

FIG. 11 is a diagram illustrating obtaining an intra-prediction mode, according to at least one embodiment of the present disclosure.

FIG. 12 is a diagram illustrating obtaining an intra-prediction mode, according to another embodiment of the present disclosure.

FIG. 13 is a diagram illustrating the generation of a predictor based on template matching, according to at least one embodiment of the present disclosure.

FIG. 14 is a diagram illustrating a refinement of an L1 motion vector, according to yet another embodiment of the present disclosure.

FIG. 15 is a diagram illustrating a case where a first directional reference picture and a second directional reference picture exist at opposite positions in time relative to the current picture.

FIG. 16 is a diagram illustrating a refinement of an L1 motion vector, according to yet another embodiment of the present disclosure.

FIGS. 17A and 17B are a flowchart of a method of encoding the current block by a video encoding apparatus, according to at least one embodiment of the present disclosure.

FIG. 18 is a flowchart of a method of reconstructing the current block by a video decoding apparatus, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

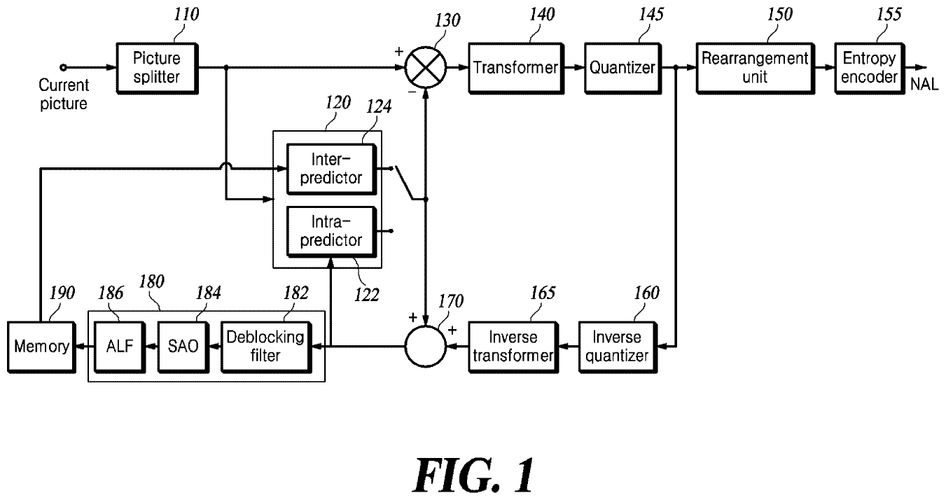

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

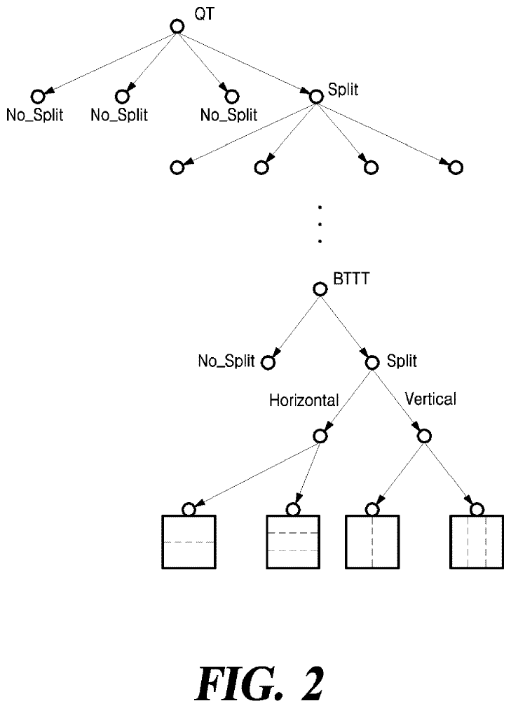

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

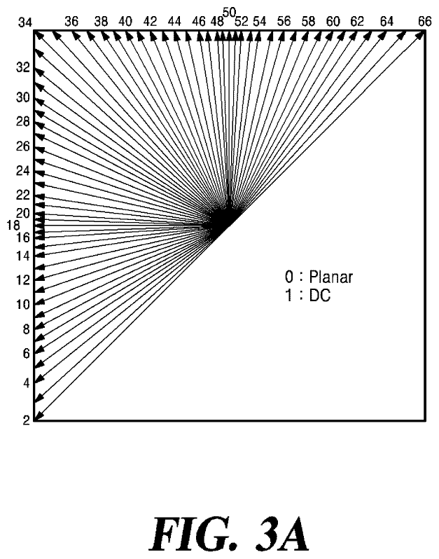

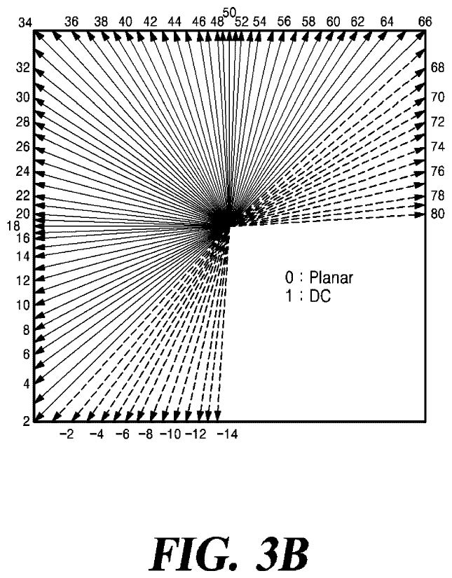

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (intra prediction modes #67 to #80, #-1 to #-14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than-135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

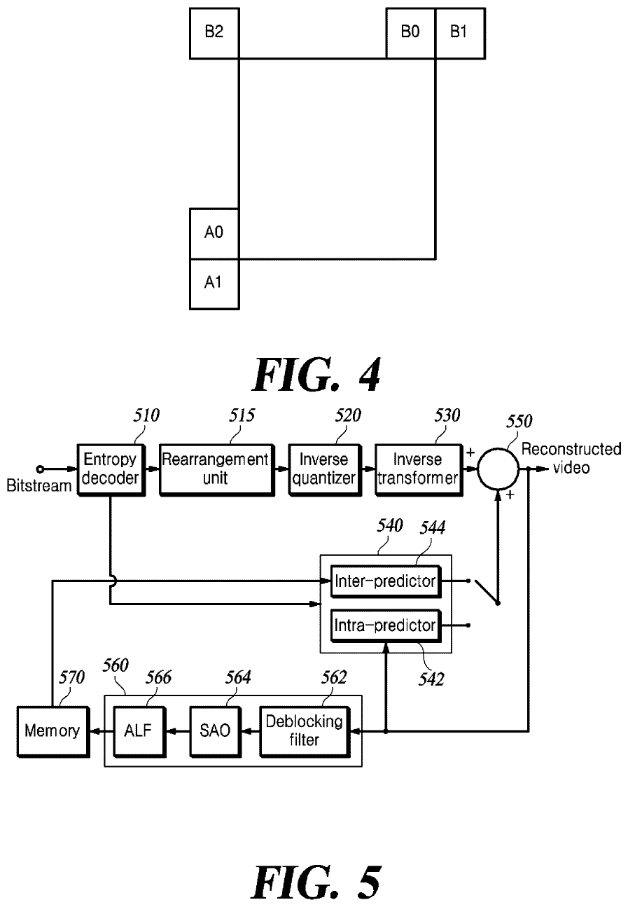

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510, and predicts the current block by using the motion vector and the reference picture.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that, when signaled in a bidirectional prediction a motion vector difference in one direction (e.g., L0 direction), but not signaled the motion vector difference in the other direction (e.g., L1 direction), use a predictor and/or intra predictor in the L0 direction to effectively refine the motion vector in the L1 direction.

The following embodiments may be performed by the predictor 120 in the video encoding device. The following embodiments may also be performed by the predictor 540 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. Symmetric Motion Vector Difference (SMVD)

There is a symmetric motion vector difference (SMVD) technique that can reduce the amount of bits transmitted compared to regular advanced motion vector prediction (regular AMVP) mode, even if just a single direction of motion vector difference (MVD) is signaled during bidirectional prediction.

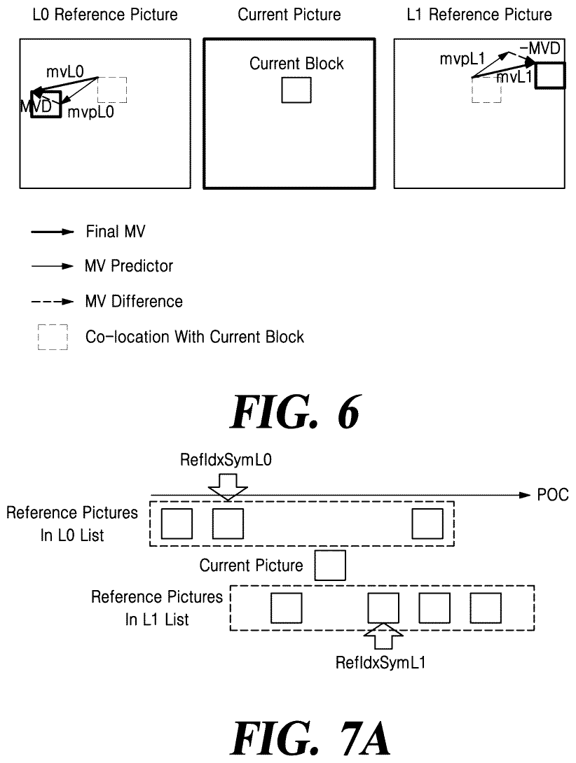

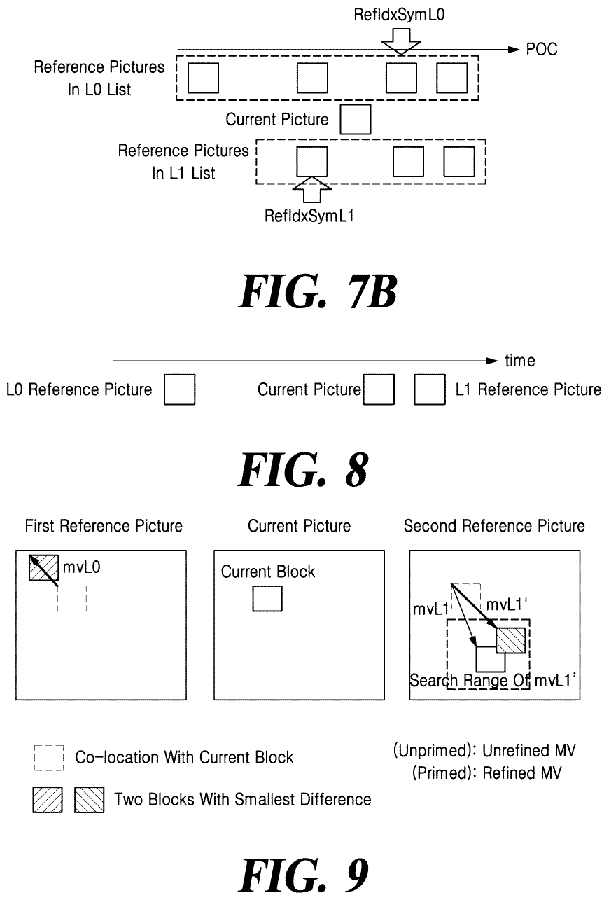

Hereinafter, the operation of SMVD is described in detail by using the illustrations of FIG. 6, FIG. 7A, and FIG. 7B.

FIG. 6 is a diagram illustrating motion vector generation according to the SMVD technique.

The SMVD technique searches for a combination of an L0 reference picture and an L1 reference picture that are located in opposite directions in the order of display relative to the current picture. From an AMVP candidate list, the SMVD technique generates motion vector predictors mvpL0 and mvpL1 in the L0 and L1 directions. The SMVD technique receives an MVD (motion vector difference) signaled in one direction and then adds the signaled MVD to mvpL0 as shown in Equation 1 to generate a motion vector mvL0 in the L0 direction. The SMVD technique also adds the sign-inverted-MVD to mvpL1 as shown in Equation 2 to generate another motion vector mvL1 in the L1 direction.

$$mvL 0 = mvpL 0 + MVD \qquad [ Equation 1 ]$$

$$mvL 1 = mvpL 1 - MVD \qquad [ Equation 2 ]$$

The video decoding apparatus may apply the SMVD technique to the current block if all of the conditions shown in Table 1 are satisfied.

TABLE 1

Current block needs to undergo bidirectional prediction.
Current block's inter_affine_flag needs to be 0.
Current picture needs to exist temporally between L0
reference picture and L1 reference picture.
Current block's sym_mvd_flag needs to be 1.

As shown in Table 1, if the current block is bi-predicted, the affine mode is not applied (inter_affine_flag=0), and the SMVD mode is enabled (sym_mvd_flag=1), the video decoding apparatus may apply the SMVD technique. In this case, the current picture needs to be temporally between the L0 reference picture and the L1 reference picture.

FIGS. 7A and 7B are diagrams illustrating the search of reference picture indices according to the SMVD technique.

The video decoding apparatus compares the display order of the current picture with the reference pictures in the L0 list and the L1 list to set the reference picture indices, RefIdxSymL0 and RefIdxSymL1 in the L0 and L1 directions of the SMVD. In one example, as illustrated in FIG. 7A, the video decoding apparatus sets RefIdxSymL0 as the index of the picture in the L0 list, which has a smaller picture order count (POC) than the current picture and has the smallest POC difference from the current picture. Further, the video decoding apparatus sets RefIdxSymL1 as the index of the picture in the L1 list, which has a larger POC than the current picture and has the smallest POC difference from the current picture.

If, as described above, the video decoding apparatus does not find a case that is listed in the order of L0 reference picture, current picture, and L1 reference picture, then, as in the example of FIG. 7B, the video decoding apparatus sets RefIdxSymL0 as the index of the picture in the L0 list, which has a greater POC than the current picture and the smallest POC difference from the current picture. Further, the video decoding apparatus sets RefIdxSymL1 as the index of the picture in the L1 list, which has a smaller POC than the current picture and the smallest POC difference from the current picture.

As described above, if the current picture is between the L0 reference picture and the L1 reference picture in the display order, the video decoding apparatus parses sym_mvd_flag to determine whether SMVD mode is enabled.

If sym_mvd_flag is 1, the video decoding apparatus generates a motion vector predictor candidate list mvpList in the L0 and L1 directions. The video decoding apparatus parses the mvpList indices, mvp_10_flag and mvp_11_flag in the L0 and L1 directions to generate motion vector predictors as shown in Equation 3.

$$mvpL 0 = mvpListL 0 [ mvp\_ 10 \_flag ] \qquad [ Equation 3 ]$$

$$mvpL 1 = mvpListL 1 [ mvp\_ 11 \_flag ]$$

The video decoding apparatus generates the motion vectors by adding the motion vector difference and the sign-inverted motion vector difference to the motion vector predictors in both directions, as shown in Equations 1 and 2, respectively. The video decoding apparatus then generates a prediction block of the current block by using the L0 reference picture, the L1 reference picture, and the final motion vectors.

However, the prior art SMVD technique receives the MVD signaled in the L0 direction and uses the sign-inverted-MVD in generating the motion vector in the L1 direction. Thus, the sign-inverted-MVD may not be optimal for generating the motion vector in the L1 direction.

Furthermore, as in the example of FIG. 8, since the current picture may not be temporally centered between the two reference pictures, the motion vector in the L1 direction according to the SMVP mode may not be properly generated with an object moving in the picture at a constant speed. Therefore, there is a need for refining the motion vector in the direction where no signal of motion vector difference is provided.

The following embodiments are described with reference to the video decoding apparatus, but they may be implemented in the same or similar manner by the video encoding apparatus.

### II. Embodiments According to the Present Disclosure

The above-described issues of the prior art can be solved with Implementation 1, Implementation 2, and Implementation 4 by comparing the L0 predictor obtained from the L0 reference picture or the intra predictor of the current block with the block in the L1 reference picture, to refine the motion vector in the L1 direction. Alternatively, the issues of the prior art can be solved with Implementation 3 and Implementation 4 by comparing the predictor generated by the weighted sum of the L0 predictor and the intra predictor, with the block in the L1 reference picture, to refine the motion vector in the L1 direction. Further, the video decoding apparatus can take Implementation 5 to use as a basis the motion vector in the L0 direction for deriving the motion vector in the L1 direction without separately signaling motion information in the L1 direction, and then refine the derived motion vector in the L1 direction by using the refining methods described above.

The following describes implementations according to the present disclosure.

Hereinafter, the L0 direction is used interchangeably with the first direction, and the L1 direction is used interchangeably with the second direction. The ‘L0 direction’ is referred to simply as ‘L0’ and the ‘L1 direction’ is referred to simply as ‘L1’. Additionally, ‘in the first direction’ is simply ‘first’ and ‘in the second direction’ is simply ‘second’. For example, the motion vector in the L0 direction is used interchangeably with the L0 motion vector, and the motion vector in the L1 direction is used interchangeably and the L1 motion vector. Additionally, the motion vector in the first direction is used interchangeably with the first motion vector, and the motion vector in the second direction is used interchangeably with the second motion vector.

### <Implementation 1> Comparing Differences Between the First Directional Predictor and Blocks in the Second Directional Reference Picture, to Refine the Second Directional Motion Vector

In this implementation, the video decoding apparatus compares differences between the blocks indicated by the first directional and second directional motion vectors to refine the second directional motion vector.

FIG. 9 is a diagram illustrating a refinement of an L1 motion vector, according to at least one embodiment of the present disclosure.

The video decoding apparatus searches within a preset search range on the second directional reference picture, for a block that has a minimum difference from the block indicated by mvL0 in the first directional reference picture, as illustrated in FIG. 9. The video decoding apparatus refines the motion vector mvL1 into a vector mvL1′ indicative of the searched block. Here, the motion vector mvL1 before the refinement is a motion vector generated according to a conventional SMVD technique. The above-described preset search range may be generated in the neighborhood of the block indicated by mvL1. In this implementation, various measures such as Mean Square Errors (MSE), Sum of Squared Errors (SSE), Sum of Absolute Differences (SAD), Sum of Absolute Transformed Differences (SATD), or the like, may be used to estimate the difference between two blocks.

### <Implementation 2> Comparing the Differences Between the Current Block's Intra Predictor and Blocks in the Second Directional Reference Picture, to Refine the Second Directional Motion Vector

In this implementation, the video decoding apparatus compares the differences between the current block's intra predictor and blocks indicated by the second directional motion vector to refine the second directional motion vector.

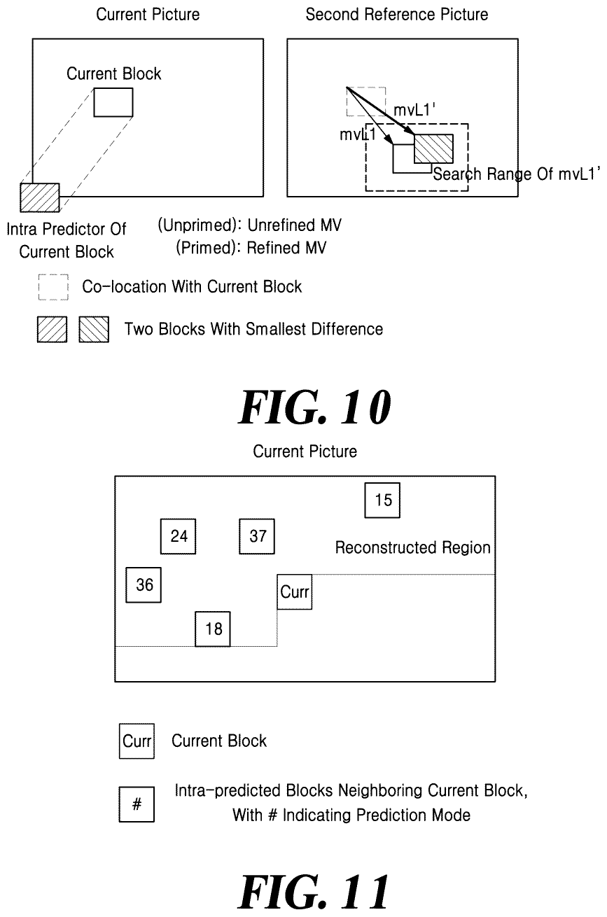

FIG. 10 is a diagram illustrating a refinement of an L1 motion vector, according to another embodiment of the present disclosure.

The video decoding apparatus searches within a preset search range on the second reference picture, for a block having a minimum difference from the intra predictor of the current block, as illustrated in FIG. 10. The video decoding apparatus refines the motion vector mvL1 into a vector mvL1′ indicative of the searched block. Here, the motion vector mvL1 before the refinement is a motion vector generated according to a conventional SMVD technique. The above-described preset search range may be generated in the neighborhood of the block indicated by mvL1. In this implementation, various measures such as MSE, SSE, SAD, SATD, or the like, may be used to estimate the difference between two blocks.

Further, in this implementation, the generation of the intra predictor used to refine the second directional motion vector and the obtaining of the prediction mode may be implemented according to various schemes. Detailed schemes of this implementation are described below.

### <Implementation 2-1> Using a Preset Prediction Mode

In this implementation, the video decoding apparatus uses a preset prediction mode as the prediction mode of the intra predictor for refining the second directional motion vector. The video decoding apparatus may use planar, DC, horizontal, vertical, or a predetermined angular mode as the preset mode. After setting the prediction mode to the preset prediction mode, the video decoding apparatus generates an intra predictor of the current block according to the set prediction mode. To refine the second directional motion vector, the video decoding apparatus utilizes the generated intra predictor.

### <Implementation 2-2> Using the Prediction Mode of Intra-Predicted Block Among the Neighbor Blocks of the Current Block

In this implementation, the video decoding apparatus utilizes the prediction mode of the intra-predicted blocks of the current block's neighbor blocks as the prediction mode of the intra predictor for refining the second directional motion vector.

FIG. 11 is a diagram illustrating obtaining an intra-prediction mode, according to at least one embodiment of the present disclosure.

As illustrated in FIG. 11, the video decoding apparatus searches for intra-predicted neighboring blocks in a reconstructed region of the current picture. The video decoding apparatus selects one of the prediction modes of the intra-predicted blocks searched in the neighborhood of the current block. For example, the video decoding apparatus may select the prediction mode with the smallest mode number or the most frequent prediction mode among the intra-prediction modes within a predetermined range centered on the current block. Alternatively, the video decoding apparatus may select the prediction mode of the intra-prediction block closest to the current block. The foregoing is by way of example only, and the present disclosure puts no restrictions on the method of selecting the prediction mode.

### <Example 2-3> Using the Prediction Mode of the Intra-Predicted Block Among the Neighboring Blocks of the Block Indicated by the First Directional Motion Vector

In this embodiment, the video decoding apparatus uses the prediction mode of the intra-predicted block among the neighboring blocks of the block indicated by the first directional motion vector, as the prediction mode of the intra predictor for refining the second directional motion vector.

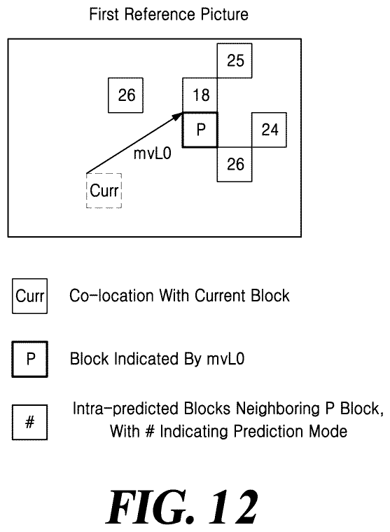

FIG. 12 is a diagram illustrating obtaining an intra-prediction mode, according to another embodiment of the present disclosure.

As illustrated in FIG. 12, the video decoding apparatus searches for intra-predicted neighboring blocks around the block (hereinafter, the P block) indicated by mvL0 in the first reference picture. The video decoding apparatus selects one of the prediction modes of the intra-predicted blocks searched around the P block. For example, the video decoding apparatus may select the prediction mode with the smallest mode number or the most frequent prediction mode among the intra-prediction modes within a predetermined range centered on the P block. Alternatively, the video decoding apparatus may select the prediction mode of the intra-predicted block closest to the P block. The foregoing is by way of example only, and the present disclosure puts no restrictions on the method of selecting the prediction mode.

### <Implementation 2-4> Deriving the Intra-Prediction Mode by Decoder-Side Intra Mode Derivation (DIMD)

In this implementation, the video decoding apparatus uses the mode derived by Decoder-side Intra Mode Derivation (DIMD) as the prediction mode of the intra predictor for refining the second directional motion vector. Instead of being signaled the intra-prediction mode of the current block from the video encoding apparatus, the video decoding apparatus derives the prediction mode according to the DIMD technique. Namely, the video decoding apparatus derives a gradient value from the template neighboring the current block, generates a histogram of gradient (HOG) from the gradient value, and derives the intra-prediction mode based on the HOG.

In this implementation, the video decoding apparatus selects one of the derived intra-prediction modes based on the DIMD. The video decoding apparatus selects the prediction mode having the smallest mode number among the prediction modes having the HOG value. The video decoding apparatus may use the prediction mode having the largest HOG value. Alternatively, the video decoding apparatus selects the two prediction modes with the largest HOG value and the second largest HOG value. The video decoding apparatus may generate predictors according to the two prediction modes, and then weight-sums the predictors to generate an intra predictor. The foregoing is by way of example only, and the present disclosure puts no restrictions on the method of selecting the prediction mode and the method of generating the predictor.

### <Implementation 2-5> Deriving an Intra Prediction Mode by Template-Based Intra Mode Derivation (TIMD)

In this implementation, the video decoding apparatus uses a mode derived by Template-based Intra Mode Derivation (TIMD) as a prediction mode of an intra predictor for refining the second directional motion vector. Instead of being signaled the intra-prediction mode of the current block from the video encoding apparatus, the video decoding apparatus derives the prediction mode according to the TIMD technique. Namely, the video decoding apparatus selects one of the intra-prediction modes in the MPM (most probable mode) list based on the template. The video decoding apparatus sets the prediction mode of the current block to the prediction mode derived according to the TIMD. In this implementation, the video decoding apparatus may use the intra-prediction mode derived according to the TIMD as the prediction mode of the intra predictor for refining the second directional motion vector.

<Implementation 2-6> Generating a Predictor by Referring to a Reconstructed Region within the Current Picture

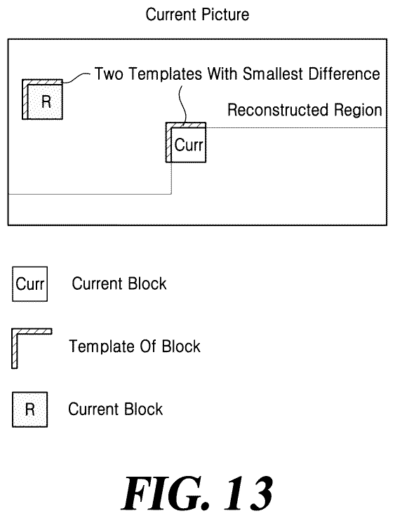

In this implementation, to generate an intra predictor of the current block, the video decoding apparatus performs template matching within the reconstructed region. As illustrated in FIG. 13, the video decoding apparatus searches for a template with the least difference from the template of the current block, and uses the block corresponding to the searched template (R block in FIG. 13) as a predictor of the current block. In this implementation, various measures such as MSE, SSE, SAD, SATD, or the like, may be used to calculate the difference between two templates.

### <Implementation 2-7> Selectively Using the Methods of Implementation 2-1 Through Implementation 2-6

In this implementation, the video decoding apparatus selectively uses the methods of Implementation 2-1 through Implementation 2-6 in generating a predictor for refining the second directional motion vector and in setting the prediction mode. Which method of Implementation 2-1 to Implementation 2-6 is to be used may be signaled at various levels, such as video parameter set (VPS), sequence parameter set (SPS), picture parameter set (PPS), picture header (PH), slice header (SH), CTU, CU, and the like. For example, as shown in Table 2, at the SPS level, a syntax element may be signaled to indicate which method of Implementation 2-1 or Implementation 2-6 is to be used.

TABLE 2
[SPS Level]

sps_single_mvd_intra_idx

In accordance with Table 2, the video decoding apparatus parses sps_single_mvd_intra_idx at the SPS level. The video decoding apparatus determines which method is to be used to derive the intra-prediction mode by using sps_single_mvd_intra_idx, according to Table 3. The way the above-mentioned syntax element is signaled at the VPS, PPS, PH, and SH levels is similar to the way it is signaled at the SPS level, as shown in Table 2.

TABLE 3

| sps_single_mvd_intra_idx | |
|---|---|
| ctu_single_mvd_intra_idx | |
| cu_single_mvd_intra_idx | Method |
| 0 | Implementation 2-1 |
| 1 | Implementation 2-2 |
| 2 | Implementation 2-3 |
| 3 | Implementation 2-4 |
| 4 | Implementation 2-5 |
| 5 | Implementation 2-6 |

The video decoding apparatus may also determine at the CTU level which of Implementation 2-1 through Implementation 2-6 is to be used to refine the second directional motion vector, as shown in Table 4.

TABLE 4
[CTU Level]

if ( modeType == MODE_TYPE_INTER ) {
ctu_single_mvd_intra_idx
}

In Table 4, if the value of modeType is equal to MODE_TYPE_INTER, the video decoding apparatus further parses ctu_single_mvd_intra_idx. The video decoding apparatus determines which method is to be used to derive the intra-prediction mode, by using ctu_single_mvd_intra_idx according to Table 3.

Further, the video decoding apparatus may determine at the CU level which method of Implementation 2-1 through Implementation 2-6 is to be used to refine the second directional motion vector, as shown in Table 5.

TABLE 5
[CTU Level]

```
if( inter_pred_idc[ x0 ][ y0 ] == PRED_BI &&
    ( ph_mvd_l1_zero_flag || sym_mvd_flag[ x0 ][ y0 ] ) )
  cu_single_mvd_intra_idx[ x0 ][ y0 ]
```

In Table 5, the video decoding apparatus checks whether the current block performs bidirectional prediction based on the value of inter_pred_idc. In addition, the video decoding apparatus checks the value of ph_mvd_11_zero_flag and the value of sym_mvd_flag. If the value of ph_mvd_11_zero_flag is 1, the video decoding apparatus does not parse the second directional motion vector difference and sets it to 0. If the value of sym_mvd_flag is 1, the video decoding apparatus performs SMVD mode. The video decoding apparatus parses the first directional motion vector difference but does not parse the second directional motion vector difference. Namely, the video decoding apparatus sets the second directional motion vector difference by the first directional motion vector difference with the sign inverted. If the value of inter_pred_idc is equal to PRED_BI and the value of ph_mvd_11_zero_flag or sym_mvd_flag is equal to 1, the video decoding apparatus parses cu_single_mvd_intra_idx. The video decoding apparatus determines which method is to be used to derive the intra-prediction mode by using cu_single_mvd_intra_idx according to Table 3.

<Implementation 3> Comparing Differences Between the Predictor Generated by the Weighted Sum of the Current Block's Intra Predictor and First Directional Predictor and Blocks in the Second Directional Reference Picture, to Refine the Second Directional Motion Vector

In this implementation, the video decoding apparatus compares differences between (1) the predictor generated by the weighted sum of the current block's intra predictor and first directional predictor and (2) the block indicated by the second directional motion vector, to refine the second directional motion vector.

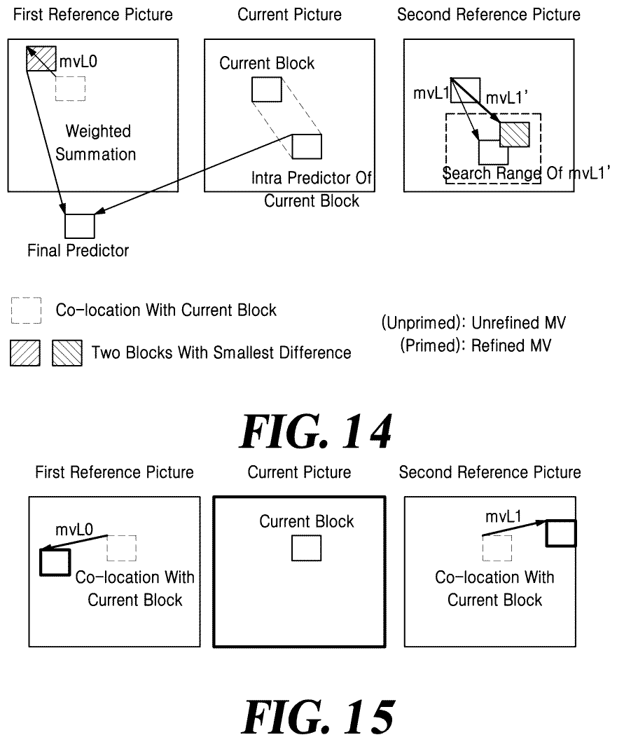

FIG. 14 is a diagram illustrating a refinement of an L1 motion vector, according to yet another embodiment of the present disclosure.

The video decoding apparatus generates a final predictor (final predictor in FIG. 14) by weight-summing the predictor indicated by the first directional motion vector in the L0 picture with the intra predictor of the current block, as illustrated in FIG. 14. The video decoding apparatus searches within the preset search range on the second reference picture, for the block that has the least difference from the final predictor. The video decoding apparatus refines the motion vector mvL1 into a vector mvL1′ indicative of the searched block. Here, the motion vector mvL1 before the refinement is a motion vector generated according to a conventional SMVD technique. The above-described preset search range may be generated in the neighborhood of the block indicated by mvL1. In this implementation, various measures such as MSE, SSE, SAD, SATD, or the like, may be used to estimate the difference between two blocks. Further, various methods according to Implementation 2 may be used to generate the intra predictor of the current block.

### <Implementation 4> Selectively Using Implementations 1, 2, and 3

In this implementation, to refine the second directional motion vector, the video decoding apparatus selectively uses the methods of Implementation 1 through Implementation 3. Which method of Implementation 1 to Implementation 3 is to be used may be signaled at various levels, such as VPS, SPS, PPS, PH, SH, CTU, CU, or the like. For example, as shown in Table 6, a syntax element may be signaled at the SPS level to indicate which method of Implementation 1 or Implementation 3 is to be used.

TABLE 6
[SPS Level]

sps_single_mvd_mvr_idx

According to Table 6, the video decoding apparatus parses sps_single_mvd_mvr_idx at the SPS level. The video decoding apparatus determines which method is to be used to refine the second directional motion vector, by using sps_single_mvd_mvr_idx, according to Table 7. The way the above-mentioned syntax element is signaled at the VPS, PPS, PH, and SH levels is similar to the way it is signaled at the SPS level, as shown in Table 6.

TABLE 7

| sps_single_mvd_mvr_idx | |
|---|---|
| ctu_single_mvd_mvr_idx | |
| cu_single_mvd_mvr_idx | Method |
| 0 | Implementation 1 |
| 1 | Implementation 2 |
| 2 | Implementation 3 |

Further, the video decoding apparatus may determine at the CTU level which of Implementation 1 to Implementation 3 is to be used to refine the second directional motion vector, as shown in Table 8.

TABLE 8
[CTU Level]

if ( modeType == MODE_TYPE_INTER ) {
ctu_single_mvd_mvr_idx
}

In Table 8, if the value of modeType is equal to MODE_TYPE_INTER, the video decoding apparatus further parses ctu_single_mvd_mvr_idx. The video decoding apparatus determines which method is to be used to refine the second directional motion vector, by using ctu_single_mvd_mvr_idx according to Table 7.

Further, the video decoding apparatus may determine at the CU level which method of Implementation 1 to Implementation 3 is to be used to refine the second directional motion vector, as shown in Table 9.

TABLE 9
[CTU Level]

```
if( inter_pred_idc[ x0 ][ y0 ] == PRED_BI &&
    ( ph_mvd_l1_zero_flag || sym_mvd_flag[ x0 ][ y0 ] ) )
  cu_single_mvd_mvr_idx[ x0 ][ y0 ]
```

In Table 9, the video decoding apparatus checks whether the current block performs bidirectional prediction based on the value of inter_pred_idc. Further, the video decoding apparatus checks the value of ph_mvd_11_zero_flag and the value of sym_mvd_flag. If the value of ph_mvd_11_zero_flag is 1, the video decoding apparatus does not parse the second directional motion vector difference and sets it to 0. If the value of sym_mvd_flag is 1, the video decoding apparatus performs SMVD mode. The video decoding apparatus parses the first directional motion vector difference but does not parse the second directional motion vector difference. Namely, the video decoding apparatus sets the second directional motion vector difference by the first directional motion vector difference with the sign inverted. If the value of inter_pred_idc is equal to PRED_BI and the value of ph_mvd_11_zero_flag or sym_mvd_flag is equal to 1, the video decoding apparatus parses cu_single_mvd_mvr_idx. The video decoding apparatus determines which method is to be used to refine the second directional motion vector, by using the cu_single_mvd_mvr_idx according to Table 7.

### <Implementation 5> Deriving the Second Directional Motion Vector by Using the First Directional Motion Vector, and Refining the Derived Second Directional Motion Vector

In this implementation, in the case of a bidirectional prediction, the video decoding apparatus derives the second directional motion vector based on the first directional motion vector without being separately signaled the second directional motion information. The video decoding apparatus then refines the derived second directional motion vector.

As in the example of FIG. 15, when the first directional reference picture and the second directional reference picture exist at opposite positions in time relative to the current picture with an object in the picture moving at a constant speed, the first directional motion vector and the second directional motion vector are in a straight line and indicate opposite directions from each other.

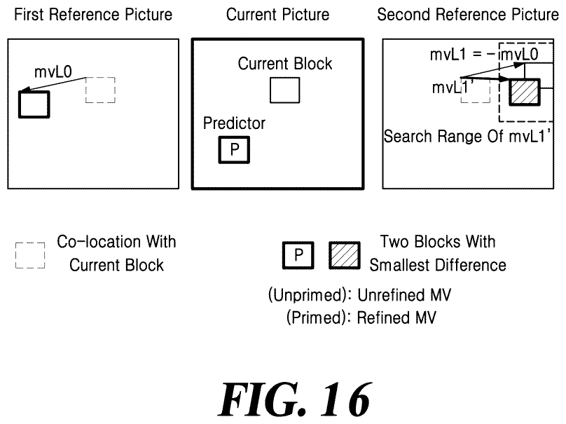

FIG. 16 is a diagram illustrating a refinement of an L1 motion vector, according to yet another embodiment of the present disclosure.

In this implementation, the video decoding apparatus derives mvL1 by inverting the sign of mvL0, as illustrated in FIG. 16, without being signaled second directional motion information, e.g., mvp_11_flag, second directional motion vector difference, and the like. The video decoding apparatus searches within a present search range on the second directional reference picture, for a block which minimizes the difference from the current block's predictor (P block in the example of FIG. 16). The video decoding apparatus refines the motion vector mvL1 into a vector mvL1′ indicative of the searched block. Here, the motion vector mvL1 before the refinement is the motion vector derived as described above. The above-described preset search range may be generated in the neighborhood of the block indicated by mvL1.

In this implementation, various measures such as MSE, SSE, SAD, SATD, or the like, may be used to estimate the difference between two blocks. Further, the methods according to any of Implementation 1 to Implementation 4 may be used to generate a predictor of the current block.

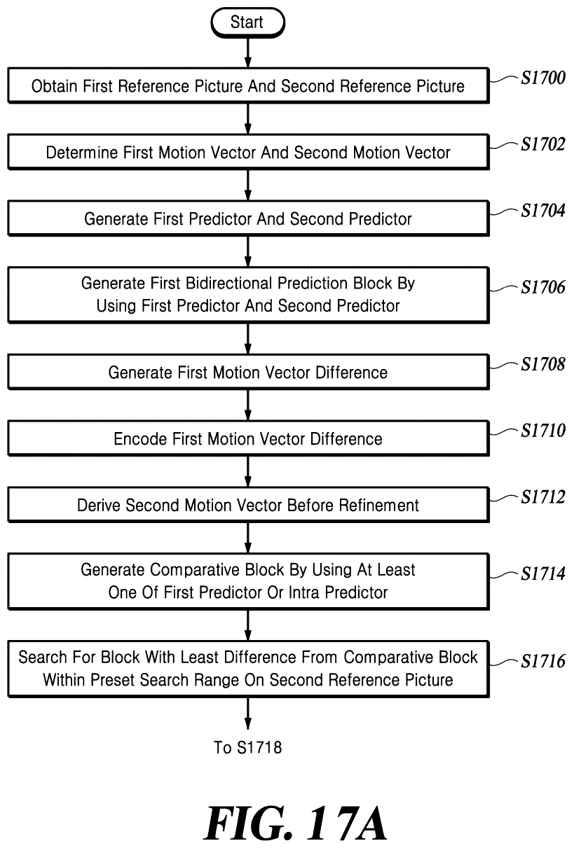

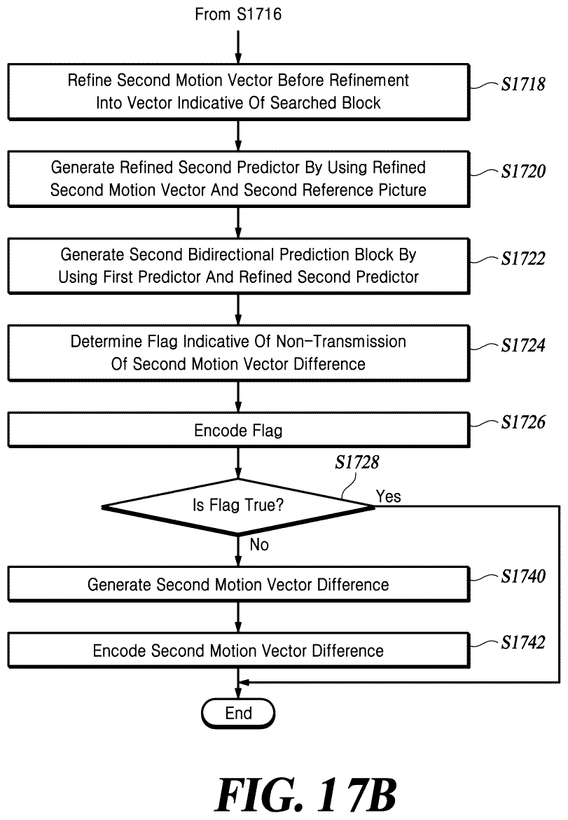

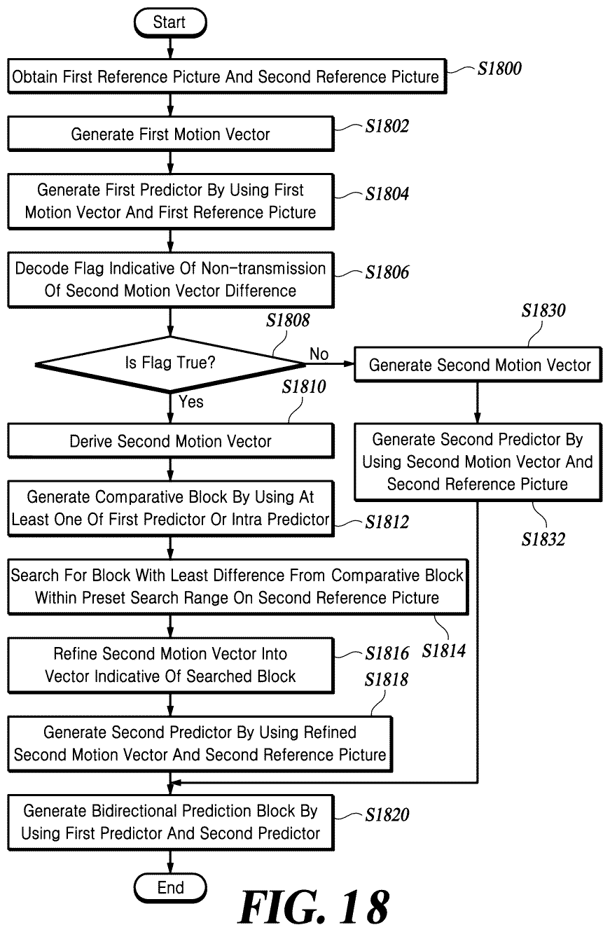

Hereinafter, with reference to the illustrations of FIGS. 17A to 18, methods are described for, when the current picture is temporally between a first reference picture and a second reference picture, refining a second motion vector.

FIGS. 17A and 17B are a flowchart of a method of encoding the current block by the video encoding apparatus, according to at least one embodiment of the present disclosure.

The video encoding apparatus obtains the first reference picture and the second reference picture of the current block (S1700). Here, the current picture is temporally between the first reference picture and the second reference picture. The video encoding apparatus sets the first reference picture and the second reference picture of the current block, as illustrated in FIG. 7A or FIG. 7B.

The video encoding apparatus determines a first motion vector and a second motion vector of the current block (S1702). In terms of rate-distortion optimization, the video encoding apparatus determines the first motion vector from the first reference picture and the second motion vector from the second reference picture.

The video encoding apparatus generates a first predictor and a second predictor of the current block (S1704). The video encoding apparatus generates the first predictor of the current block by using the first motion vector and the first reference picture, and generates the second predictor of the current block using the second motion vector and the second reference picture.

The video encoding apparatus generates a first bidirectional prediction block of the current block by using the first predictor and the second predictor (S1706). For example, the video encoding apparatus may generate the first bidirectional prediction block by weight-summing the first predictor and the second predictor.

The video encoding apparatus generates a first motion vector difference of the current block (S1708).

For example, the video encoding apparatus may generate a first motion vector predictor candidate list, and then obtain a first motion vector predictor of the current block based on the first motion vector predictor candidate list and the first motion vector (0194). The video encoding apparatus determines an index indicative of the first motion vector predictor in the candidate list of first motion vector predictors. The video encoding apparatus subtracts the first motion vector predictor from the first motion vector to generate a first motion vector difference.

The video encoding apparatus encodes the index indicating the first motion vector predictor and the first motion vector difference (S1710).

The video encoding apparatus derives the second motion vector before refinement (S1712).

The video encoding apparatus derives the second motion vector before refinement according to the SMVD technique or Implementation 5.

According to the SMVD technique, the video encoding apparatus generates a candidate list of second motion vector predictors and then obtains a second motion vector predictor of the current block based on the candidate list of second motion vector predictors and the second motion vector. The video encoding apparatus may derive the second motion vector before refinement by summing the second motion vector predictor and the sign-inverted first motion vector difference.

Alternatively, the video encoding apparatus according to Implementation 5 may derive the second motion vector before refinement by inverting the sign of the first motion vector.

The video encoding apparatus generates a comparative block by using at least one of the first predictor of the current block or the intra predictor of the current block (S1714).

According to Implementation 1, the video encoding apparatus may generate the above-described comparative block. Namely, the video encoding apparatus sets the comparative block as the first predictor.

According to Implementation 2, the video encoding apparatus may generate the comparative block. Namely, the video encoding apparatus generates the intra predictor of the current block according to Implementation 2-1 through Implementation 2-7, and then sets the intra predictor to the comparative block.

According to Implementation 3, the video encoding apparatus may generate the comparative block. Namely, the video encoding apparatus generates the intra predictor according to Implementation 2. The video encoding apparatus generates a block that is a weighted sum of the first predictor and the intra predictor, and then sets the comparative block by the weight-summed block.

According to Implementation 4, the video encoding apparatus may generate the comparative block. The video decoding apparatus obtains an index indicating the method of generating the comparative block according to Implementation 1, Implementation 2, or Implementation 3. The video encoding apparatus determines the above-described index in terms of rate-distortion optimization, or obtains it from a high level. The video encoding apparatus takes the above-described index to use the first predictor as the comparative block, to use the intra predictor as the comparative block, or to use a block generated by weight-summing the first predictor and the intra predictor as the comparative block.

The video encoding apparatus searches within a preset search range on the second reference picture, for a block having a minimum difference from the comparative block (S1716). The preset search range may be set around the second motion vector before refinement.

The video encoding apparatus refines the second motion vector before refinement into a vector indicative of the searched block (S1718).

The video encoding apparatus generates the refined second predictor (S1720). The video encoding apparatus generates a refined second predictor by using the refined second motion vector and the second reference picture.

The video encoding apparatus generates a second bidirectional prediction block of the current block by using the first predictor and the refined second predictor (S1722). For example, the video encoding apparatus may generate the second bidirectional prediction block by weight-summing the first predictor and the refined second predictor.

The video encoding apparatus uses the first bidirectional prediction block and the second bidirectional prediction block to determine a flag indicative of non-transmission of the second motion vector difference (S1724). The flag indicates that the second motion vector difference is not transmitted, and therefore, the second motion vector is derived by the video decoding apparatus. The video encoding apparatus may determine the flag in terms of rate-distortion optimization. For example, if the first bidirectional prediction block is optimal, the flag is determined to be false. On the other hand, if the second bidirectional prediction block is optimal, the flag is determined to be true.

The video encoding apparatus encodes the flag (S1726).

The video encoding apparatus checks the flag (S1728).

If the flag is true (Yes in S1728), the video encoding apparatus omits encoding and transmitting the second motion vector difference. Since the second motion vector difference is not transmitted, the video decoding apparatus derives the second motion vector before refinement according to the SMVD technique or implementation 5.

If the flag is false (No in S1728), the video encoding apparatus performs the following steps.

The video encoding apparatus generates a second motion vector difference for the current block (S1740).

After generating the candidate list of second motion vector predictors, the video encoding apparatus obtains a second motion vector predictor of the current block based on the candidate list of second motion vector predictors and the second motion vector. The video encoding apparatus determines an index indicative of the second motion vector predictor in the candidate list of second motion vector predictors. The video encoding apparatus subtracts the second motion vector predictor from the second motion vector to generate a second motion vector difference.

The video encoding apparatus encodes the index indicative of the second motion vector predictor and the second motion vector difference (S1742).

The video encoding apparatus then subtracts the first bidirectional prediction block or the second bidirectional prediction block from the current block based on the flag to generate a residual block. The video encoding apparatus applies a transform/quantization to the residual block to generate transform coefficients, and then encodes the quantized transform coefficients.

FIG. 18 is a flowchart of a method of reconstructing the current block by the video decoding apparatus, according to at least one embodiment of the present disclosure.

The video decoding apparatus obtains a first reference picture and a second reference picture of the current block (S1800). Here, the current picture is temporally between the first reference picture and the second reference picture. The video decoding apparatus sets the first reference picture and the second reference picture of the current block, as illustrated in FIG. 7A or FIG. 7B.

The video decoding apparatus generates a first motion vector of the current block (S1802).

For example, the video decoding apparatus decodes from the bitstream the index indicative of a first motion vector predictor and the first motion vector difference. After generating the candidate list of first motion vector predictors, the video decoding apparatus obtains a first motion vector predictor of the current block based on the candidate list of first motion vector predictors and the decoded index. The video decoding apparatus generates the first motion vector by summing the first motion vector predictor and the first motion vector difference.

The video decoding apparatus generates a first predictor of the current block by using the first motion vector and the first reference picture (S1804)

The video decoding apparatus decodes a flag indicative of non-transmission of the second motion vector difference from the bitstream (S1806).

The video decoding apparatus checks the flag (S1808).

If the flag is true (Yes at S1808), the video decoding apparatus takes the following steps.

The video decoding apparatus derives the second motion vector (S1810).

Since the second motion vector difference is not transmitted, the video decoding apparatus derives the second motion vector according to the SMVD technique or according to Implementation 5.

According to the SMVD technique, the video decoding apparatus decodes an index indicative of the second motion vector predictor from the bitstream. The video decoding apparatus generates a candidate list of second motion vector predictors, and then obtains the second motion vector predictor of the current block based on the candidate list of second motion vector predictors and the decoded index. The video decoding apparatus derives the second motion vector by summing the second motion vector predictor and the sign-inverted first motion vector difference.

Alternatively, according to Implementation 5, the video decoding apparatus may invert the sign of the first motion vector to derive the second motion vector.

The video decoding apparatus generates a comparative block by using at least one of the first predictor of the current block or the intra predictor of the current block (S1812).

According to Implementation 1, the video decoding apparatus may generate the above-described comparative block. For example, the video decoding apparatus sets the first predictor to the comparative block.

According to Implementation 2, the video decoding apparatus may generate the comparative block. For example, the video decoding apparatus generates the intra predictor of the current block according to Implementation 2-1 through Implementation 2-7, and then sets the intra predictor to the comparative block.

According to Implementation 3, the video decoding apparatus may generate the comparative block. Namely, the video decoding apparatus generates an intra predictor according to Implementation 2. The video decoding apparatus generates a block that is a weighted sum of the first predictor and the intra predictor, and then sets the weight-summed sum to the comparative block.

According to Implementation 4, the video decoding apparatus may generate the comparative block. The video decoding apparatus obtains an index indicative of a method of generating the comparative block according to Implementation 1, Implementation 2, or Implementation 3. The video decoding apparatus decodes the above-described index from the bitstream or obtains it from a high level. The video decoding apparatus takes the above-described index to use the first predictor as the comparative block, to use the intra predictor as the comparative block, or to use a block generated by weight-summing the first predictor and the intra predictor as the comparative block.

The video decoding apparatus searches within a preset search range on the second reference picture, for a block that has the least difference from the comparative block (S1814). The preset search range may be set around the derived second motion vector.

The video decoding apparatus refines the second motion vector into a vector indicative of the searched block (S1816).

The video decoding apparatus uses the refined second motion vector and the second reference picture to generate a second predictor of the current block (S1818).

On the other hand, if the flag is false (No in S1808), the video decoding apparatus takes the following steps.

The video decoding apparatus generates a second motion vector of the current block (S1830).

For example, the video decoding apparatus decodes from the bitstream the index indicative of a second motion vector predictor and the second motion vector difference. The video decoding apparatus generates a candidate list of second motion vector predictors, and then obtains a second motion vector predictor of the current block based on the candidate list of second motion vector predictors and the decoded index. The video decoding apparatus generates a second motion vector by summing the second motion vector predictor and the second motion vector difference.

The video decoding apparatus generates a second predictor of the current block by using the second motion vector and the second reference picture (S1832).

After generating different second predictors based on the flag, the video decoding apparatus generates a bidirectional prediction block of the current block by using the first predictor and the second predictor (S1820).

The video decoding apparatus then decodes quantized transform coefficients from the bitstream and applies inverse quantization/inverse transform to the quantized transform coefficients to generate a residual block. The video decoding apparatus sums the residual block and the bidirectional prediction block to generate a reconstructed block of the current block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

120: intra predictor
155: entropy encoder
510: entropy decoder
540: intra predictor

### CROSS-REFERENCE TO RELATED APPLICATIONS

This application claims priority to and the benefit of Korean Patent Application No. 10-2023-0048702 filed on Apr. 13, 2023, and Korean Patent Application No. 10-2024-0015111, filed on Jan. 31, 2024, the entire contents of each of which are incorporated herein by reference.

1. A method of reconstructing a current block by a video decoding apparatus, the method comprising:
obtaining a first reference picture and a second reference picture of the current block, with a current picture existing temporally between the first reference picture and the second reference picture;
generating a first motion vector of the current block;
generating a first predictor of the current block by using the first motion vector and the first reference picture;
generating a comparative block by using at least one of the first predictor or an intra predictor of the current block;
searching for a block having a minimum difference from the comparative block, within a preset search range on the second reference picture; and
refining a second motion vector by a vector indicative of a searched block.

2. The method of claim 1, further comprising:
decoding, from a bitstream, a flag indicative of non-transmission of a second motion vector difference; and
checking the flag of the non-transmission,
wherein the method further comprises, when the flag of the non-transmission is true:
proceeding with generating the comparative block through refining the second motion vector.

3. The method of claim 2, further comprising, when the flag of the non-transmission is true:
generating a second predictor of the current block by using the refined second motion vector and the second reference picture; and
generating a bidirectional prediction block of the current block by using the first predictor and the second predictor.

4. The method of claim 2, further comprising, when the flag of the non-transmission is false:
generating the second motion vector by obtaining a second motion vector predictor of the current block, decoding a second motion vector difference from the bitstream, and then summing the second motion vector predictor and the second motion vector difference;
generating a second predictor of the current block by using the second motion vector and the second reference picture; and
generating a bidirectional prediction block of the current block by using the first predictor and the second predictor.

5. The method of claim 1, wherein generating the first motion vector comprises:
generating the first motion vector by obtaining a first motion vector predictor of the current block, decoding a first motion vector difference from a bitstream, and then summing the first motion vector predictor and the first motion vector difference.

6. The method of claim 1, wherein generating the comparative block comprises:
setting the comparative block by the first predictor.

7. The method of claim 1, wherein generating the comparative block comprises:
generating the intra predictor; and
setting the comparative block by the intra predictor.

8. The method of claim 1, wherein generating the comparative block comprises:
generating the intra predictor;
generating a block by weight-summing the first predictor and the intra predictor; and
setting the comparative block by a weight-summed block.

9. The method of claim 1, wherein generating the comparative block comprises:
obtaining an index indicative of a method of generating the comparative block; and
depending on the index, using either the first predictor as the comparative block, the intra predictor as the comparative block, or a block generated by weight-summing the first predictor and the intra predictor as the comparative block.

10. The method of claim 7, wherein generating the intra predictor comprises:
generating the intra predictor by using a preset prediction mode.

11. The method of claim 7, wherein generating the intra predictor comprises:
searching for intra-predicted blocks around the current block;
selecting one prediction mode among prediction modes of the intra-predicted blocks, according to a preset method; and
generating the intra predictor by using a selected prediction mode.

12. The method of claim 7, wherein generating the intra predictor comprises:
searching for intra-predicted blocks around a block indicated by the first motion vector on the first reference picture;
selecting one prediction mode among prediction modes of the intra-predicted blocks, according to a preset method; and
generating the intra predictor by using a selected prediction mode.

13. The method of claim 7, wherein generating the intra predictor comprises:
deriving a prediction mode according to a Decoder-side Intra Mode Derivation (DIMD) technique; and
generating the intra predictor by using a derived prediction mode.

14. The method of claim 7, wherein generating the intra predictor comprises:
deriving a prediction mode according to a Template-based Intra Mode Derivation (TIMD) technique; and
generating the intra predictor by using the derived prediction mode.

15. The method of claim 7, wherein generating the intra predictor comprises:
performing template matching in a reconstructed area in the current picture to search for a template having a minimum difference from a template of the current block; and
using a block corresponding to a searched template as the intra predictor.

16. A method of encoding a current block by a video encoding apparatus, the method comprising:
obtaining a first reference picture and a second reference picture of the current block, with a current picture existing temporally between the first reference picture and the second reference picture;
determining a first motion vector and a second motion vector of the current block;
generating a first predictor of the current block by using the first motion vector and the first reference picture, and generating a second predictor of the current block by using the second motion vector and the second reference picture;
generating a first bidirectional prediction block of the current block by using the first predictor and the second predictor;
generating a comparative block by using at least one of the first predictor or an intra predictor of the current block;
searching for a block having a minimum difference from the comparative block, within a preset search range on the second reference picture;
refining the second motion vector with a vector indicative of a searched block;
generating a refined second predictor by using a refined second motion vector and the second reference picture; and
generating a second bidirectional prediction block of the current block by using the first predictor and the refined second predictor.

17. The method of claim 16, further comprising:
determining a flag indicative of non-transmission of a second motion vector difference by using the first bidirectional prediction block and the second bidirectional prediction block; and
encoding the flag of the non-transmission.

18. The method of claim 17, further comprising:
generating a first motion vector difference by obtaining a first motion vector predictor of the current block and subtracting the first motion vector predictor from the first motion vector; and
encoding the first motion vector difference.

19. The method of claim 18, further comprising:
checking the flag of the non-transmission,
wherein the method further comprises, when the flag of the non-transmission is false:
generating a second motion vector difference by obtaining a second motion vector predictor of the current block and subtracting the second motion vector predictor from the second motion vector; and
encoding the second motion vector difference.

20. A computer-readable recording medium storing a bitstream generated by a video encoding method, wherein the video encoding method comprises:
obtaining a first reference picture and a second reference picture of a current block, with a current picture existing temporally between the first reference picture and the second reference picture;
determining a first motion vector and a second motion vector of the current block;
generating a first predictor of the current block by using the first motion vector and the first reference picture, and generating a second predictor of the current block by using the second motion vector and the second reference picture;
generating a first bidirectional prediction block of the current block by using the first predictor and the second predictor;
generating a comparative block by using at least one of the first predictor or an intra predictor of the current block;
searching for a block having a minimum difference from the comparative block, within a preset search range on the second reference picture;
refining the second motion vector with a vector indicative of a searched block;
generating a refined second predictor by using a refined second motion vector and the second reference picture; and
generating a second bidirectional prediction block of the current block by using the first predictor and the refined second predictor.
